(19) United States
(12) Patent Application Publication
(10) Pub. No.: US 2020/0078259 A1
(43) Pub. Date: Mar. 12, 2020

(54) Sex toy

(71) Applicant: Vicky Murray, Carson, CA (US)

(72) Inventor: Vicky Murray, Carson, CA (US)

(73) Assignee: MyFriend.Com, LLC, Carson, CA (US)

(21) Appl. No.: 16/357,561

(22) Filed: May 20, 2019

Related U.S. Application Data
(60) Provisional application No. 62/645,567, filed on Mar. 20, 2018.

(51) Int. Cl. A61H 19/00; A61H 7/00

(52) U.S. Cl. CPC A61H 19/30; A61H 7/003; A61H 2205/085; A61H 2205/082; A61H 2205/087; A61H 2201/1253

(57) ABSTRACT

Motor Technology for a traditional sex toy can be inexpensive or you can have a premium motor. The Cheaper version has existing D.C. motors for most toys.

Motor Orientation will need 8 motors for maximum, 6 for premium or 2-3 for traditional power. Ergonomics: Intensity of the vibration, rotation and speed control, with three speeds of vibration. This toy can run on batteries alone or batteries and motors, or a USB magnetic charger receiver for quick charge.

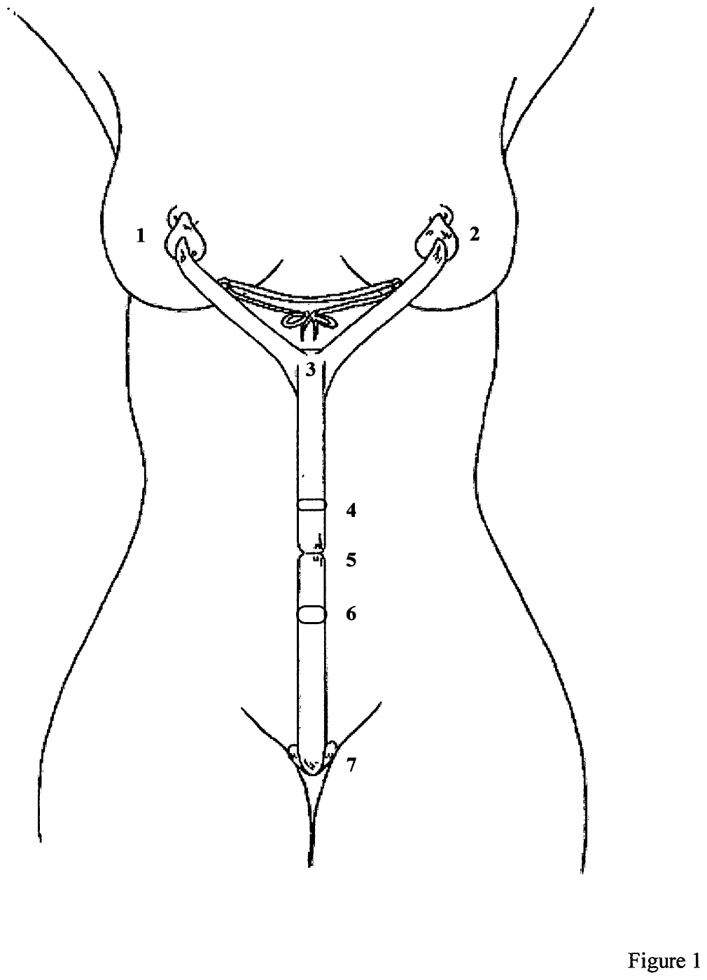

FIG. 1

1. The tongue that massages the breast.

2. The tongue that massages the breast.

3. The strap to hold the tongues in place.

4. The on/off switch.

5. Where the toy collapses to fit inside a velvet bag.

6. The extension to lengthen or shorten the toy.

7. Tongue to massage the vaginal/groin area.

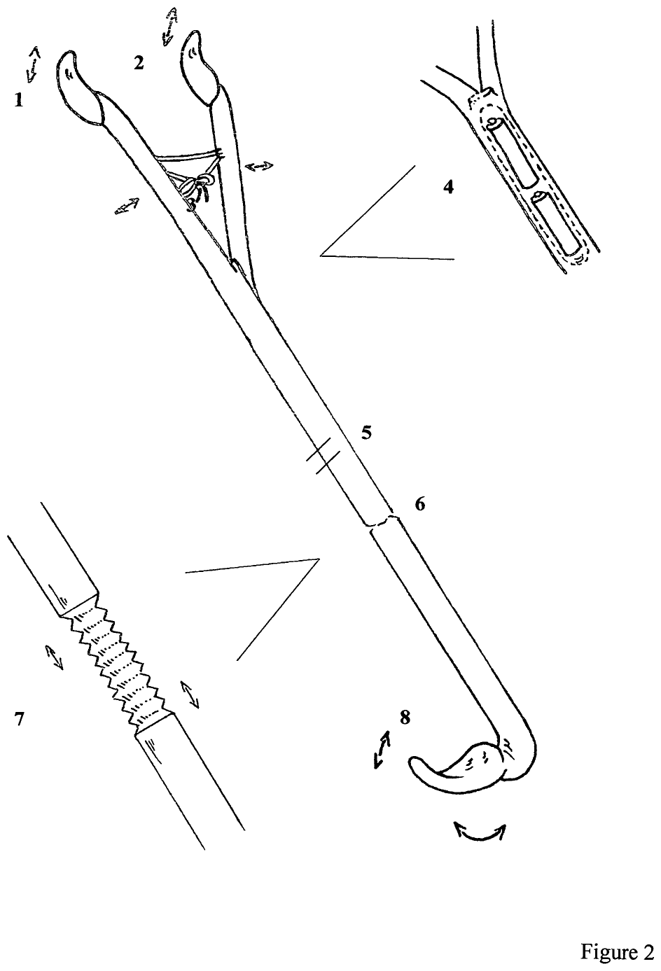

FIG. 2

1. Tongue to massage the breast.

2. Tongue to massage the breast.

3. Strap to hold tongues in place.

4. USB/Rechargeable.

5. On/Off Switch.

6. Collapses to fit into a velvet bag.

7. Extension to fit according to height.

8. Tongue to massage the vaginal/groin area.

### DESCRIPTION

This sex toy is designed to massage the breasts, while simultaneously massaging the vaginal/groin area, unlike any other sex toy imagined. It sits on top of the body, as the tongues slowly or quickly, depending on your wishes, massage the nipples with three (3) different speeds. It gives the feeling of being in a ménage a trois all by yourself. It massages the perineal area on the male body stimulating the prostate gland which houses the nerve endings to the penis. There is also a tie-strap across the front to secure the tongues in place.

1. The Sex Toy is shaped like a “Y” with tongues on each end. Each tongue massages the nipples and vaginal/groin region. The purpose is to bring you to orgasmic heights like no other toy on the market. There is also a collapsible feature that allows it to fit into a velvet bag for travel.

2. This sex toy will massage the upper region (nipples) and the lower region (vaginal/groin) area simultaneously giving you the feeling of being in a ménage a trios all by yourself, bringing you to orgasmic heights like you've never experienced before. The sex toy is also conducive for safe sex, where you can enjoy it in the privacy of your home or while traveling for business or pleasure.

3. Sex Toy will also massage the perinea gland on the male body, which in turn, stimulates the prostate gland which holds the nerve endings to the male “G” Spot, giving the male a stronger erection, a more powerful ejaculation with several layers of pleasure.

4. (canceled)

5. (canceled)

6. (canceled)
